(19) United States
(12) Patent Application Publication
(10) Pub. No.: US 2020/0340785 A1
(43) Pub. Date: Oct. 29, 2020

(54) Stun Gun Attachment for Mobile Devices

(71) Applicant: Fayzan Ammar Ali, Saint Louis, MO (US)

(72) Inventor: Fayzan Ammar Ali, Saint Louis, MO (US)

(21) Appl. No.: 16/850,674

(22) Filed: Apr. 16, 2020

Related U.S. Application Data
(60) Provisional application No. 62/837,683, filed on Apr. 23, 2019.

(51) Int. Cl. F41H 13/00; H04M 1/725

(52) U.S. Cl. CPC F41H 13/0018; H04M 1/72541

(57) ABSTRACT

The invention disclosed herein introduces a self-defense stun gun attachment designed for mobile devices. According to various aspects of the present disclosure, the invention includes an enclosure, a battery, a stun gun module, and an attachment mechanism. The enclosure contains the internal components of the invention. The battery provides electrical power to the disclosed invention, and discretionally, other electrical devices. The stun gun module amplifies the electrical power supplied by the battery and outputs an electric shock intended for self-defense. The attachment mechanism serves to secure the enclosure onto a mobile device.

### CROSS-REFERENCE TO RELATED APPLICATIONS

This application claims priority to U.S. Provisional Application No. 62/837,683 entitled Pocket Shock It, filed Apr. 23, 2019, which is hereby incorporated by reference in its entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

### 1. Field of the Invention

This invention relates to mobile device accessories. To be more specific, this invention pertains to mobile device accessories containing self-defense functionalities and a battery component used to power the mobile device accessory.

### 2. Description of Related Art

According to the FBI's 2018 released crime report, 7,196,045 property crimes were committed in the United States. These crimes include larceny-theft, burglary, aggravated assault, murder vehicle theft, robbery, rape, murder, and unintentional manslaughter. Because of this alarmingly high and increasing crime rate, it is becoming more important for people living in the United States to equip themselves with an effective method of self-defense.

Current solutions on the market geared toward protecting people from property crimes include pepper spray, personal alarms and whistles, pocketknives, and firearms. However, many of these solutions prove to be ineffective as their bulky size makes carrying around a self-defense device a major inconvenience, in turn, failing to protect people from violent crimes.

According to the Pew Research Center 96% of Americans own a mobile phone of some kind. Additionally, according to the Pew Research Center, 90% of mobile phone owners frequently carry their mobile phone with them. Currently, the main solution on the market geared towards protecting people from property crimes that attempts to utilize a mobile phone for the self-defense device is a phone case or covering with self-defense functionalities. However, the current phone case or covering solution is extremely expensive, preventing people with a lower socioeconomic status who may face property crimes to stay protected without undergoing a financial burden. Furthermore, the phone case or cover solution fails to reach a large portion of people who may face property crimes because the phone case or cover solution only supports a small group of mobile phone models, preventing people with unsupported mobile phone models from utilizing the self-defense case.

### BRIEF SUMMARY OF THE INVENTION

The first objective of this invention is to provide a convenient and effective means of self-defense that is always at the user's disposal. The effectiveness of the invention is achieved by attaching the invention to the user's mobile device, which enables the user to temporarily stun an aggressive attacker and ensures the user is equipped with the invention as long they have their mobile device with them. The convenience of the device is achieved in two ways. First, the invention securely fits onto the user's mobile device, adding minimal bulk to the mobile device compared to previous solutions, in turn, allowing the user to feel more comfortable when carrying and pocketing the device. Additionally, the invention is not designed or used as a mobile device case; the invention is not designed to create a protective covering for the mobile device nor is it attached onto the entirety of the mobile device. This utility provides an economic convenience for the user as all devices can utilize the invention and stay protected without having to inconveniently purchase a mobile phone model that is supported by the phone case.

The invention disclosed herein describes an apparatus for a mobile device. The apparatus comprising an enclosure, a stun gun module, a battery, and an attachment mechanism. The enclosure contains all components necessary for the invention to function and be operated safely. The stun gun module of the invention is designed to release an electric shock to an aggressive attacker and protect the user. The battery is used to provide energy to the stun gun module and is responsible for enabling the electric shock. The attachment mechanism is configured to secure the disclosed invention onto a mobile device.

A mobile device is defined as a portable computing device; the definition of “mobile device” encompasses any device that is portable and contains a processor and memory, including smart telephones and cellular telephones, e.g. an Android phone or an iPhone, handheld tablets, personal digital assistants, and iPods.

Further features of the invention will become apparent from the accompanying figures and detailed description which follows.

### BRIEF DESCRIPTION OF THE SEVERAL VIEWS OF THE DRAWING

FIGS. 1A, 1B, 1C, 1D, 1E, 1F, and 1G illustrate one embodiment of the stun gun mobile phone attachment in a closed position.

FIGS. 2A, 2B, 2C, 2D, 2E, 2F, and 2G illustrate one embodiment of the stun gun mobile phone attachment in an open position.

FIGS. 3A and 3B illustrate one embodiment of the stun gun mobile phone attachment secured onto a sample mobile device.

FIG. 4 illustrates one embodiment of the stun gun mobile phone attachment, demonstrating how the presently disclosed device attaches to the mobile device.

FIGS. 5A, 5B, 5C, and 5D illustrate one embodiment of the stun gun mobile phone attachment, demonstrating how the safety mechanism of the presently disclosed device functions.

FIG. 6 illustrates a box diagram of one embodiment of the stun gun mobile device attachment

FIG. 7 illustrates a sample circuit schematic of the voltage booster within the stun gun mobile device attachment.

### DETAILED DESCRIPTION OF THE INVENTION

References in this description to “an embodiment”, “one embodiment”, or the like, mean that the particular feature, function, or characteristic being described is included in at least one embodiment of the present disclosure. Occurrences of such phrases in this description do not necessarily all refer to the same embodiment, nor are they necessarily mutually exclusive.

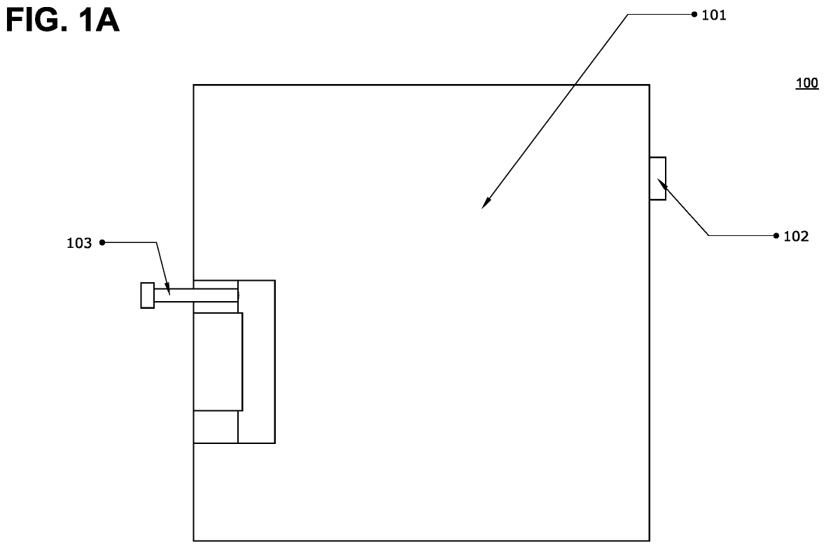

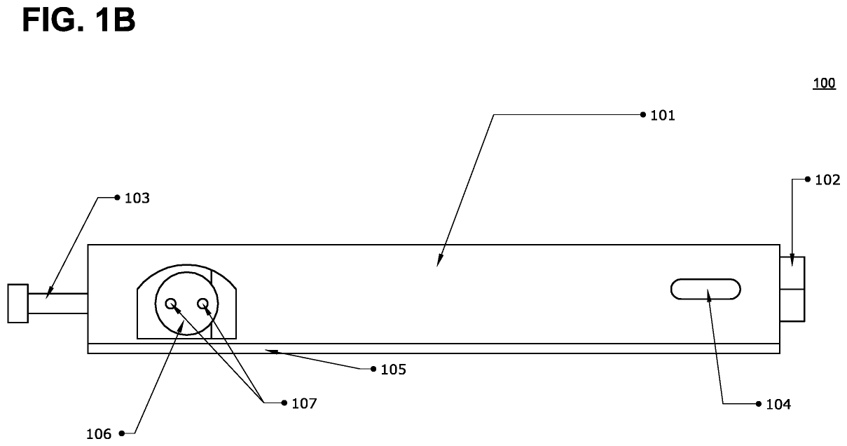

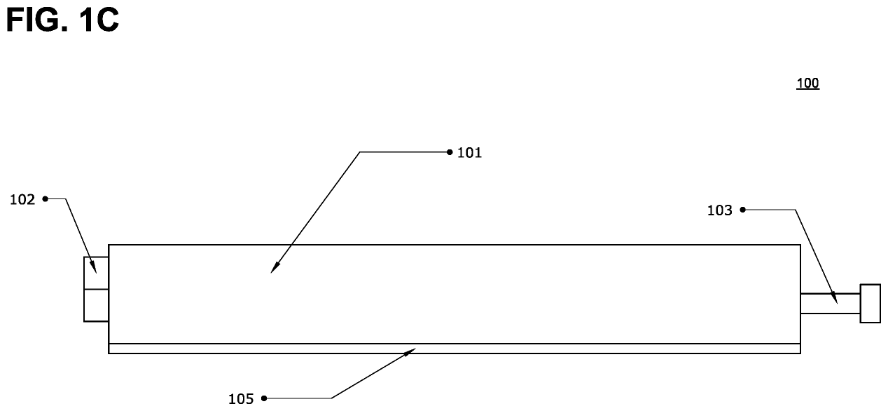

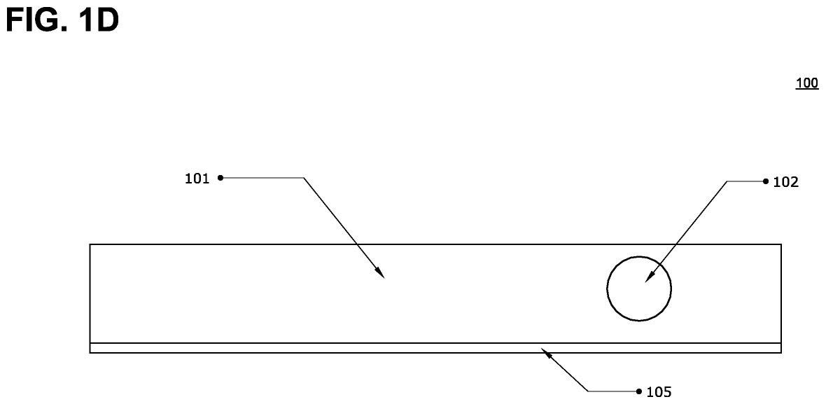

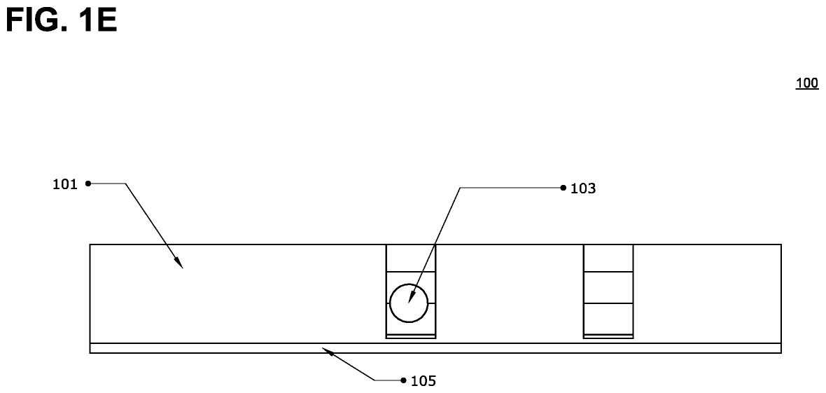

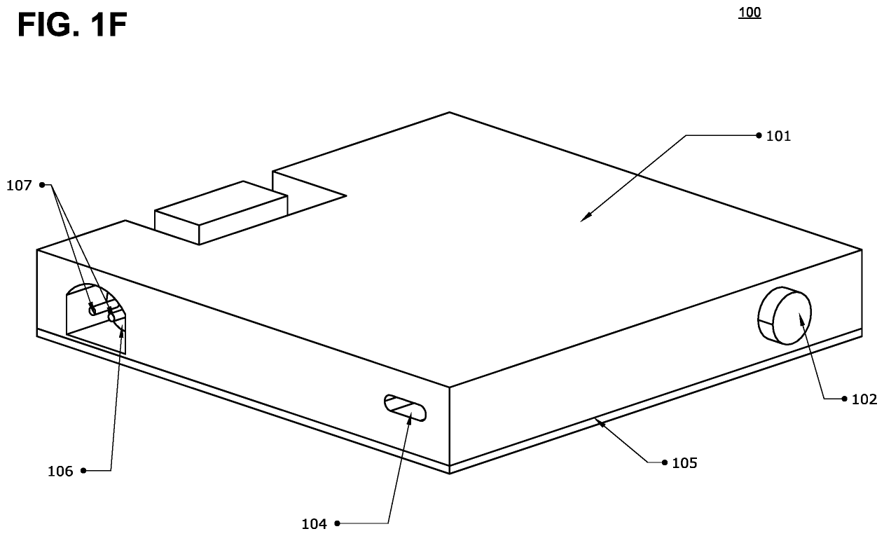

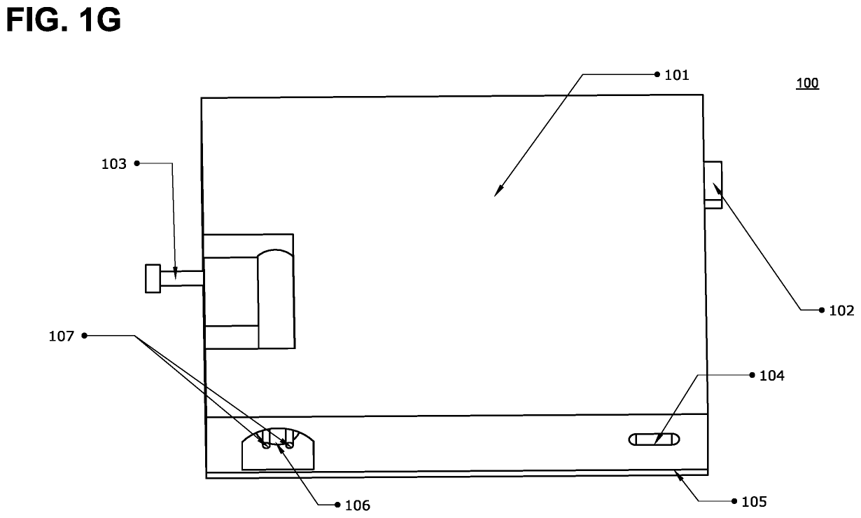

FIGS. 1A, 1B, 1C, 1D, 1E, 1F, and 1G illustrate a device 100 in a closed position according to one embodiment of the present disclosure. FIG. 1A is a top view of a device 100. FIG. 1B is a front view of a device 100. FIG. 1C is a back view of a device 100. FIG. 1D is a right-side view of a device 100. FIG. 1E is a left-side view of a device 100. FIG. 1F is an isometric view of a device 100. FIG. 1G is a perspective view of a device 100 as seen from the front and top. In one embodiment, a device 100 includes an enclosure 101, an activator 102, a safety mechanism 103, an external port 104, an attachment mechanism 105, an extension piece 106, and electrodes 107.

The enclosure 101 can be made of metal, plastic, wood, 3D printing filaments, silicon, rubber, or any other type of material as contemplated by a person having any skill in the art. The enclosure 101 holds many of the internal components of the device 100. In one embodiment, the internal components the enclosure 101 may hold include a battery, internal wiring, switches, or other necessary components.

The enclosure 101 of the device 100 attaches to a mobile device through an attachment mechanism 105. The attachment mechanism 105 is any device that allows the enclosure 101 to attach to a mobile device through mechanical adhesion, including tape, glue, hook and loop fasteners, epoxy, etc., or magnetic adhesion.

The device 100 includes a rechargeable battery (not pictured) inside the enclosure 101 that is able to be recharged through an external port 104. The external port 104 allows for an external charging cable to attach to the external port 104. The cable attached to the external port 104 allows the device's battery (not pictured) to be charged or for the device 100 to charge other electrical devices using the device's battery (not pictured).

The device 100 contains a stun gun module within the enclosure 101 that is powered by a battery within the enclosure 101. FIGS. 1A, 1B, 1C, 1D, 1E, 1F, and 1G illustrate a device 100 with a safety mechanism 103 in an open position. While the safety mechanism 103 is in the closed position, a safety switch within the enclosure (not pictured) is pressed preventing accidental shocks. To set the device 100 in a ready-to-operate position, the safety mechanism 103 is placed in the open position (not pictured in FIGS. 1A, 1B, 1C, 1D, 1E, 1F, and 1G). While the safety mechanism is in the open position, the electrodes 107 and an extension piece 106 are protruded outside of the enclosure 101.

The electrodes 107 serve as the location where electricity is output. The extension piece 106 serves to isolate wires containing high levels of electricity, preventing device malfunctions. In one embodiment, the extension piece 106 may contain external utilities such as a flashlight.

While the safety mechanism 103 is in an open position, high levels of electricity can be output through the electrodes 107 by pressing an activator 102. The activator 102 can be a button lever, switch, or other device that can permit and restrict the flow of electricity in a circuit. While the activator 102 is pressed, the circuit within the enclosure 101 is closed and electricity can flow towards the electrodes 107, given that the safety mechanism 103 is in the open position. While the activator 102 is released, the circuit within the enclosure 101 is open and electricity is restricted from flowing towards the electrodes 107.

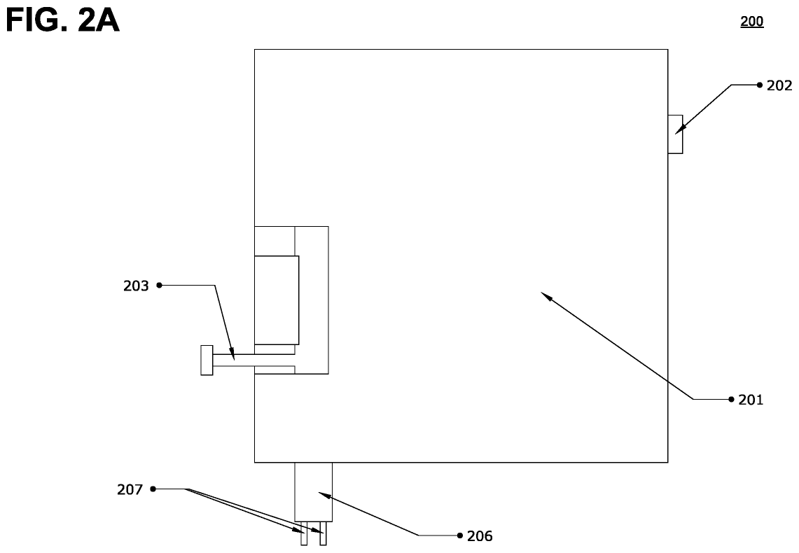

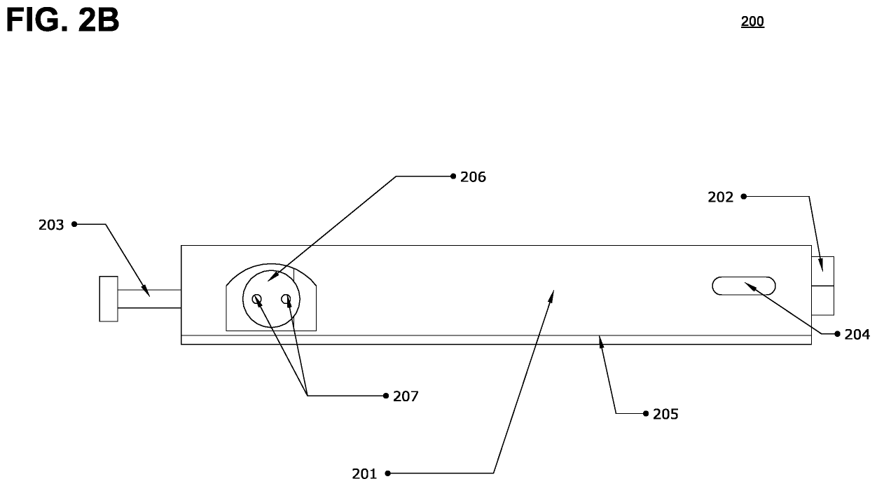

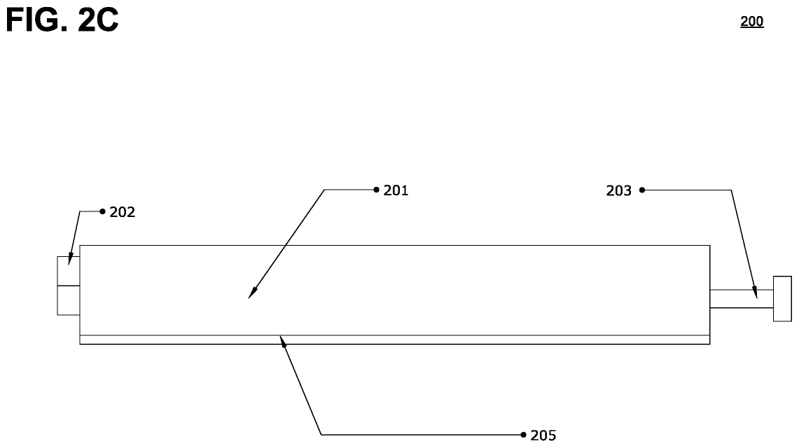

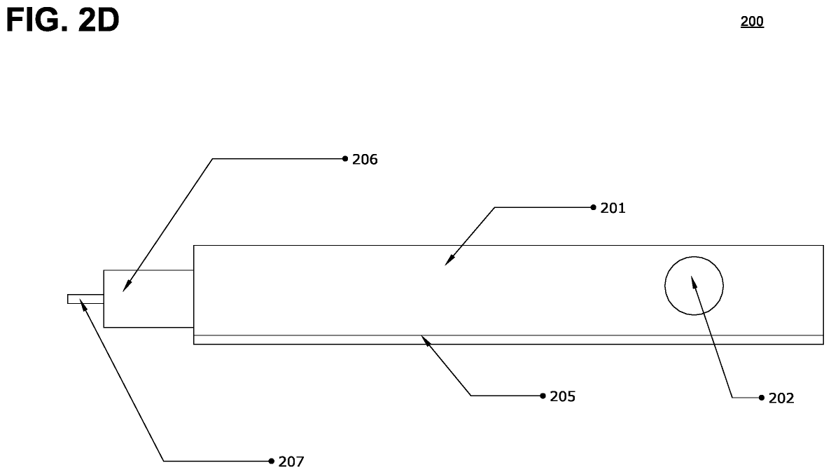

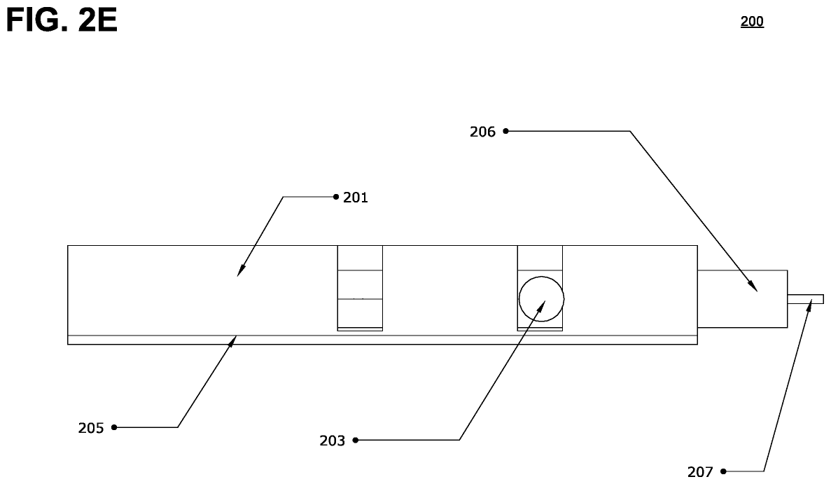

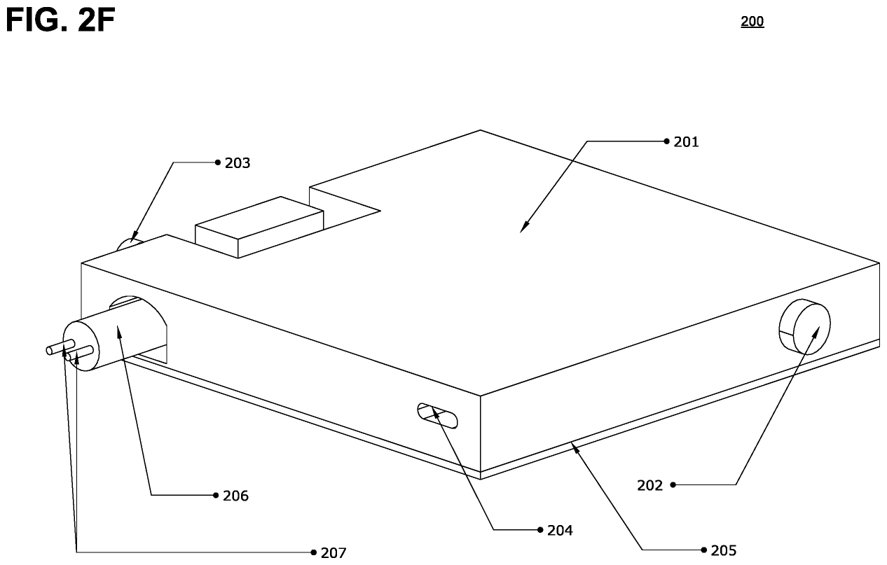

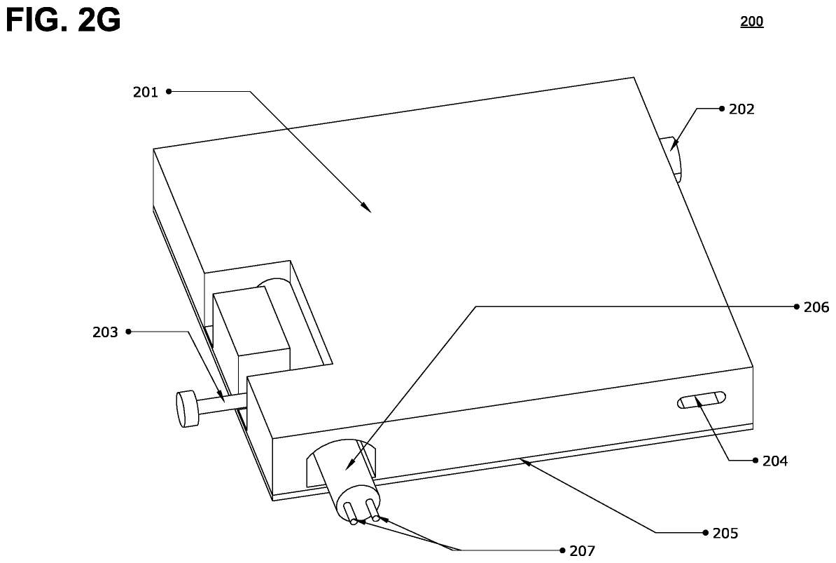

FIGS. 2A, 2B, 2C, 2D, 2E, 2F, and 2G illustrate a device 200 in an open position according to one embodiment of the present disclosure. FIG. 2A is a top view of a device 200. FIG. 2B is a front view of a device 200. FIG. 2C is a back view of a device 200. FIG. 2D is a right-side view of a device 200. FIG. 2E is a left-side view of a device 200. FIG. 2F is an isometric view of a device 200. FIG. 2G is a perspective view of a device 200 as seen from the front and top. In one embodiment, a device 200 includes an enclosure 201, an activator 202, a safety mechanism 203, an external port 204, an attachment mechanism 205, an extension piece 206, and electrodes 207.

FIGS. 2A, 2B, 2C, 2D, 2E, 2F, and 2G illustrate a device 200 with a safety mechanism 203 in an open position. While the safety mechanism is in the open position, the electrodes 207 and an extension piece 206 are protruded outside of the enclosure 201. While the safety mechanism 203 is in an open position, high levels of electricity can be output through the electrodes 207 by pressing an activator 202.

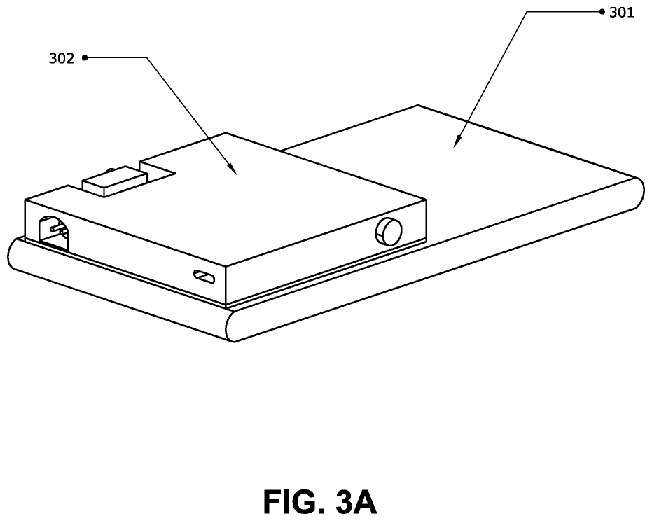

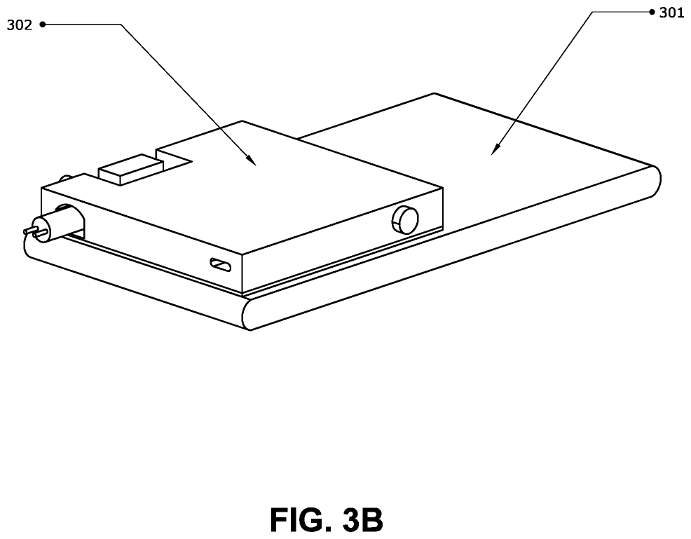

FIGS. 3A and 3B illustrate one embodiment of the present disclosure attached onto a sample mobile device. FIG. 3A is an isometric view a device 302 in a closed position onto a sample mobile device 301 according to one embodiment of the present disclosure. FIG. 3B is an isometric view of a device 302 in an open position attached onto a sample mobile device 302 according to one embodiment of the present disclosure.

While the device 302 is attached onto a mobile device 301 and in a closed position, as pictured in FIG. 3A, electricity is restricted from being output to the electrodes in the device 302. This prevents a potential user from encountering any accidental shocks that may harm the user or the mobile device 301.

While the device 302 is attached onto a mobile device 301 and in an open position, as pictured in FIG. 3B, electricity is restricted from being output to the electrodes in the device 302 unless the activator of the device 302 is pressed, allowing electricity to be output. This allows a user to control the output of electric shocks and protect himself/herself from a potential threat or aggressive attacker that may harm the user. The electrodes of the device 302, where electricity is output, extends beyond the mobile device 301. This prevents any damage towards the mobile device 301 from any usage of the device 302.

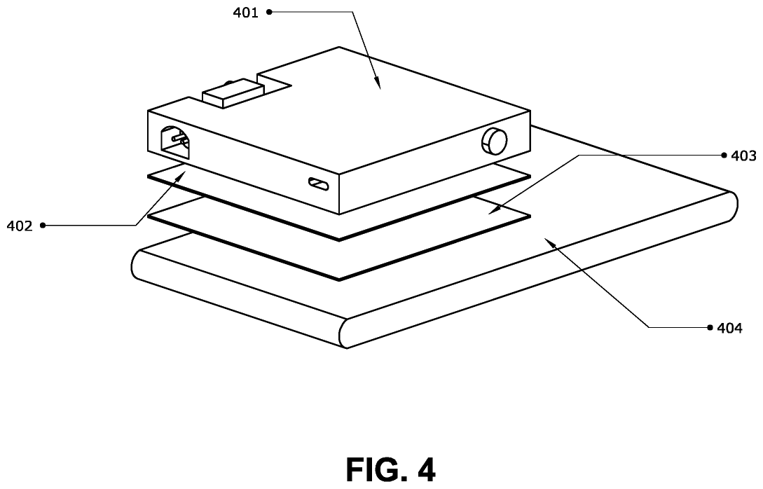

FIG. 4 illustrates a sample mechanism for attaching a device onto a sample mobile device according to one embodiment of the present disclosure. As shown in FIG. 4 the attachment mechanism includes a device 401, an upper attachment mechanism 402, a lower attachment mechanism 403, and a sample mobile device 404.

The upper attachment mechanism 402 contains two different sides. The side of the upper attachment mechanism 402 facing the device 401 adheres to the device 401 through mechanical adhesion, including glue and tape. The side of the upper attachment mechanism 402 facing the lower attachment mechanism 403 contains another form of mechanical or magnetic adhesion that allows the device 401 to detach from the mobile device 404, including loop and hook fasteners and magnets.

The lower attachment mechanism 403 contains two different sides. The side of the lower attachment mechanism 403 facing the upper attachment mechanism 402 contains a form of mechanical or magnetic adhesion that allows the mobile device 404 to detach from the device 401, including loop and hook fasteners and magnets. The side of the lower attachment mechanism 403 facing the mobile device 404 adheres to the mobile device 404 through mechanical adhesion, including glue and tape.

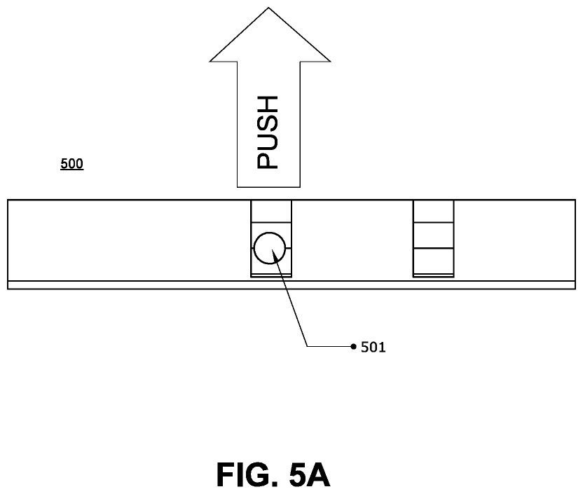

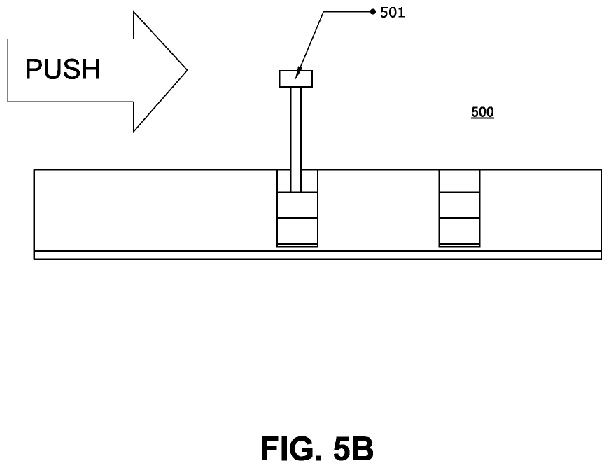

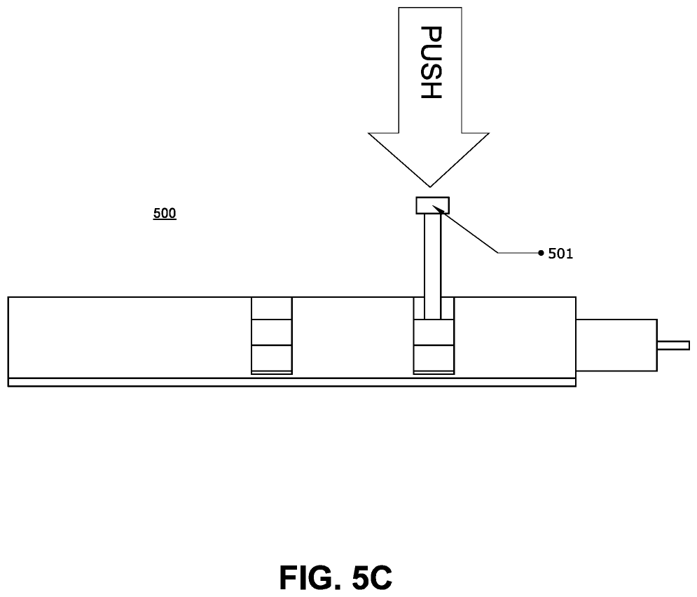

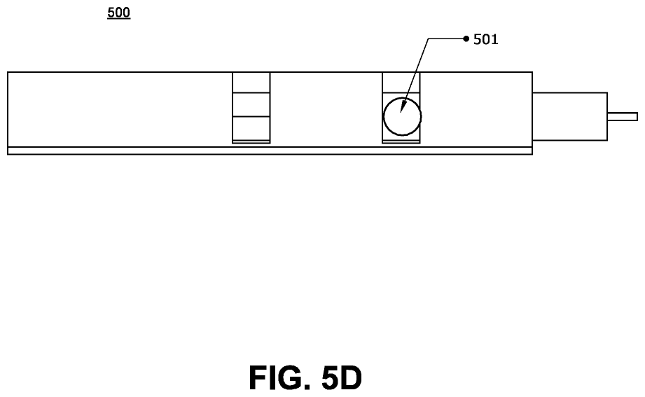

FIGS. 5A, 5B, 5C, and 5D illustrate the operation of a sample safety mechanism according to one embodiment of the present disclosure. In one embodiment of the present disclosure, a device 500 includes a safety mechanism 501. To release electricity from the device 500, the safety mechanism 501 must be in an open position. In one embodiment of the present disclosure, the process of changing the safety mechanism 501 from a closed position to an open position includes a first transition phase and a second transition phase.

FIG. 5A is a left-side view of a device 500 with the safety mechanism 501 in a closed position. While the safety mechanism 501 is in a closed position, a safety switch (not pictured) within the device 500 is pressed, restricting the flow of electricity. To change the safety mechanism 501 into the first transition phase, the safety mechanism 501 is pushed upwards, changing the position of the safety mechanism 501 from horizontal to vertical.

FIG. 5B is a left-side view of a device 500 with the safety mechanism 501 the first transition phase. While the safety mechanism 501 is in the first transition phase, a safety switch (not pictured) within the device 500 is pressed, restricting the flow of electricity. To change safety mechanism 501 from the first transition phase into the second transition phase, the safety mechanism 501 is pushed horizontally, towards the front of the device 500.

FIG. 5C is a left-side view of a device 500 with the safety mechanism 501 the second transition phase. While the safety mechanism 501 is in the second transition phase, a safety switch (not pictured) within the device 500 is released, allowing electricity to be output when an activator (not pictured) is pressed. To change safety mechanism 501 from the second transition phase into the open position, the safety mechanism 501 is pushed downward, changing the position of the safety mechanism 501 from vertical to horizontal.

FIG. 5D is a left-side view of a device 500 with the safety mechanism 501 in an open position. While the safety mechanism 501 is in an open position, a safety switch (not pictured) within the device 500 is released, allowing electricity to be output when an activator (not pictured) is pressed. While the device 500 in in the open position, the safety mechanism 501 is locked into that position until the user chooses to change the safety mechanism 501 to the closed position, preventing the user from accidentally shocking themselves with the device 500.

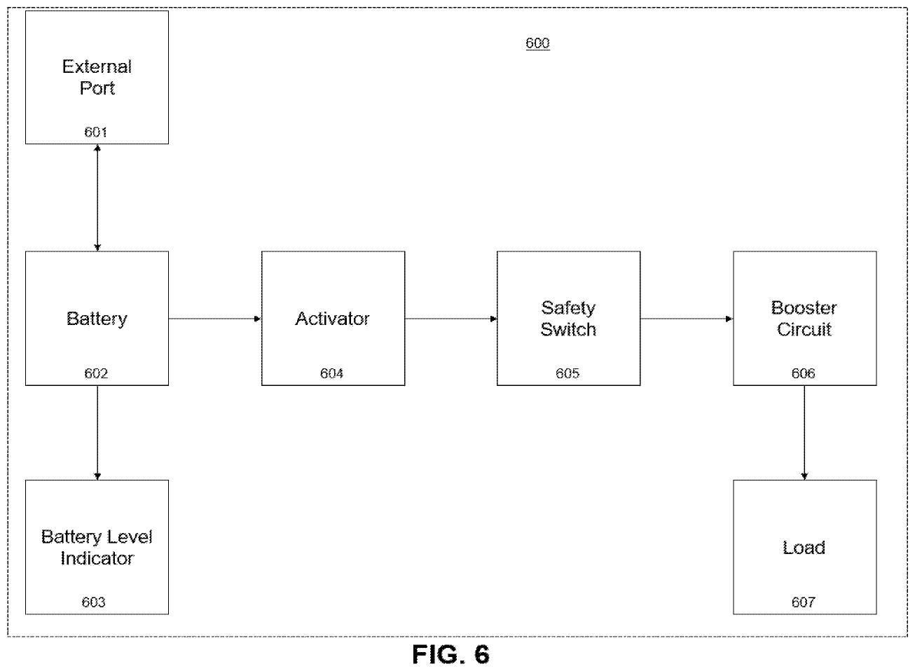

FIG. 6 is a sample block diagram of the electronic components within a self-defense device according to one embodiment of the present disclosure 600. In one embodiment, the self-defense device 600 includes an external port 601, a battery 602, a battery level indicator 603, an activator 604, a safety switch 605, a booster circuit 606, and a load 607.

The device 600 includes a battery 602 that is able to be recharged through an external port 601. The external port 601 allows for an external charging cable to attach to the external port 601. The cable attached to the external port 601 allows the device's battery 602 to be charged or for the device 600 to charge other electrical devices using the device's 602.

The device 600, in one embodiment of the present disclosure, includes a battery level indicator 603. The battery level indicator 603 allows a potential user of the device to know the power level of the battery 602, allowing the user to know when to recharge the battery 602 using the external port 601. The battery level indicator 603 also serves as a charging indicator, allowing the user to know when the battery 602 is fully charged.

The device 600 includes an activator 604, which controls the flow of electricity while the device 600 is in an open position. While the activator 604 is pressed, the circuit in the device 600 is closed and electricity is allowed to flow towards the load 607. While the activator 604 is released, the circuit in the device 600 is open and electricity is restricted from flowing towards the load 607. The device is in an open position when the safety switch 605 is released.

The device 600 includes a safety mechanism (not pictured). While the device is in a closed position, the safety mechanism (not pictured) pushes a safety switch 605, which opens the circuit within the device 600 and electricity is prevented from flowing towards the load 607. While the device is in an open position, the safety mechanism (not pictured) releases a safety switch 605, which closes a circuit within the device 600 and electricity is allowed to flow towards the load 607.

While the activator 604 is pressed and the safety switch 605 is released, electricity is able to flow from the battery 602 into a booster circuit 606. The booster circuit 606 amplifies the voltage from the battery 602 to level where it can induce a non-lethal shock to a potential attacker. After the voltage from the battery 602 is amplified through the booster circuit 607, the electricity flows into a load 607 where the electricity is output through the electrodes (not pictured) of the device 600.

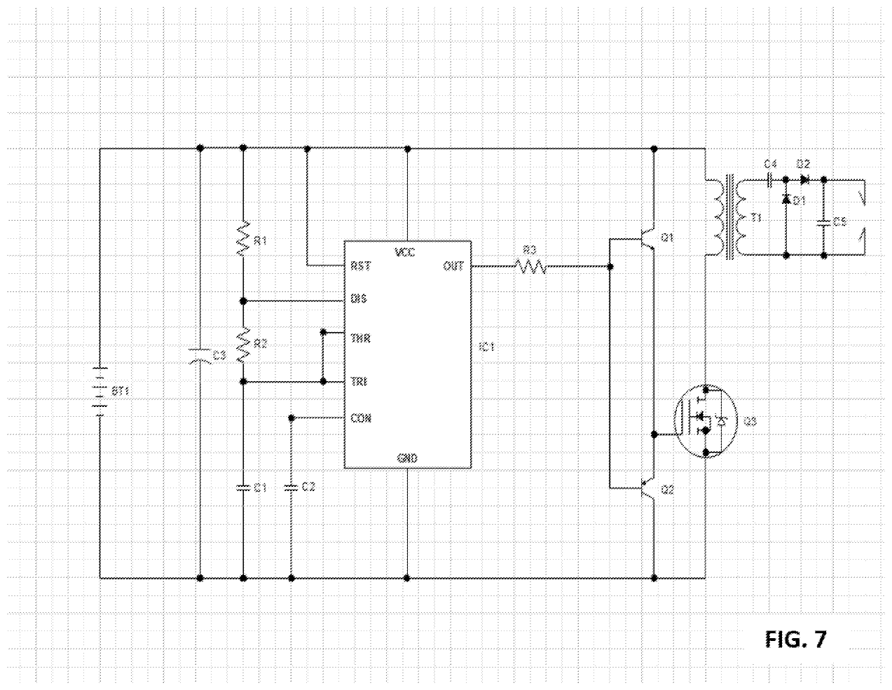

FIG. 7 is a sample circuit diagram of the booster circuit of the self-defense device 600 according to one embodiment of the present disclosure. In one embodiment, the boosting circuit includes a battery BT1, capacitors C1, C2, C3, C4, and C5, resistors R1, R2, and R3, an integrated circuit IC1, transistors Q1, Q2, and Q3, diodes D1 and D2, and a transformer T1, which allow the initial voltage from the battery to be increased to a level where it can induce a non-lethal shock to a potential attacker.

What is claimed:

1. An apparatus for a mobile device, the apparatus comprising:
a. An enclosure with a shape able to hold the internal components of the apparatus;
b. A stun gun module located inside the enclosure configured to output an electric shock, wherein the stun gun module includes:
i. Electrodes arranged within the enclosure configured to output an electric shock;
ii. A boosting circuit arranged within the enclosure configured to amplify the voltage form a power source outside of the booster circuit;
c. A battery arranged within the enclosure configured to provide electrical power to the stun gun module and other internal components within the enclosure;
d. An attachment mechanism arranged on the outside of the enclosure configured to secure the enclosure to a mobile device, wherein the attachment mechanism uses mechanical or magnetic adhesives configured to secure the enclosure to a mobile device through mechanical or magnetic adhesion.

2. The apparatus of claim 1, further comprising an activator, which prepares the stun gun module to output an electric shock when the activator is activated.

3. The apparatus of claim 2, wherein the activator is comprised of a button, switch, or other device capable of interrupting and closing an electrical circuit.

4. The apparatus of claim 1, further comprising an extension piece within the enclosure configured to extrude the electrodes of the stun gun module outside of the enclosure.

5. The apparatus of claim 4, further comprising a push lever attached to the extension piece, configured to extrude the extension piece outside of the enclosure.

6. The apparatus of claim 1, further comprising a safety mechanism within the enclosure configured to prevent a user from accidentally releasing an electric shock, wherein the safety mechanism includes a safety switch capable of preventing electrical flow into the stun gun module.

7. The apparatus of claim 6, wherein the safety switch is comprised of a button, switch, or other device capable of interrupting and closing an electrical circuit.

8. The apparatus of claim 1, further comprising an external port within the enclosure configured to allow an external cable to connect to the external port.

9. The apparatus of claim 8, wherein the external port is configured to allow an external cable to charge the battery.

10. The apparatus of claim 8, wherein the external port is configured to allow an external cable to use the battery to charge another electrical device.

11. The apparatus of claim 1, further comprising an integrated circuit configured to control the process of charging the battery.

12. The apparatus of claim 11, wherein the integrated circuit prevents the battery from supplying electrical power to another electrical device through the external port.

13. The apparatus of claim 1, further comprising a battery level indicator configure to show the electrical energy remaining in the battery.

14. The apparatus of claim 1, further comprising a flashlight powered by the battery.

15. The apparatus of claim 1, wherein the stun gun module is further configured to emit a sound while outputting an electric shock.

16. The apparatus of claim 1, wherein the attachment mechanism is further configured to allow a removable attachment to a mobile device, permitting the enclosure to detach and reattach to the mobile device through the attachment mechanism.
